(19) United States
(12) Patent Application Publication
(10) Pub. No.: US 2013/0125131 A1
(43) Pub. Date: May 16, 2013

(54) MULTI-CORE PROCESSOR SYSTEM, THREAD CONTROL METHOD, AND COMPUTER PRODUCT

(71) Applicant: FUJITSU LIMITED, Kawasaki-shi (JP)

(72) Inventors: Koichiro YAMASHITA, Hachioji (JP); Kiyoshi MIYAZAKI, Machida (JP); Hiromasa YAMAUCHI, Kawasaki (JP); Takahisa SUZUKI, Kawasaki (JP); Koji KURIHARA, Kawasaki (JP)

(73) Assignee: FUJITSU LIMITED, Kawasaki-shi (JP)

(21) Appl. No.: 13/734,498

(22) Filed: Jan. 4, 2013

Related U.S. Application Data
(63) Continuation of application No. PCT/JP2010/062909, filed on Jul. 30, 2010.

(51) Int. Cl. G06F 9/50

(52) U.S. Cl. 718/104

(57) ABSTRACT

A multi-core processor system includes a first core configured to detect a state where a first thread that is allocated to a first core and a second thread that is allocated to a second core access a common resource; calculate, upon detecting the state and based on a first cycle for the first thread to be allocated to the first core and a second cycle for the second thread to be allocated to the second core, a contention cycle for the first and the second threads to cause access contention for the resource; and select a thread allocated at a time before or after the contention cycle of a core to which a given thread that is either the first or the second thread is allocated at the contention cycle; and a second core configured to switch the times at which the given thread and the selected thread are allocated.

### CROSS REFERENCE TO RELATED APPLICATIONS

This application is a continuation application of International Application PCT/JP2010/062909, filed on Jul. 30, 2010 and designating the U.S., the entire contents of which are incorporated herein by reference.

### FIELD

The embodiments discussed herein are related to a multi-core processor system controlling a thread, a thread control method, and a thread control program.

### BACKGROUND

Conventionally, a multi-core processor system having embedded devices is operated sharing resources such as hardware resources among CPUs and threads. For example, a tightly-coupled multiprocessor system typified by a shared memory is operated sharing memory among CPUs. In addition to shared resource, a file system and an I/O device are also among shared resources. There are roughly three methods of implementing a sharing of resources, including a queuing method, a cache method, and a priority method.

The queuing method is a method of registering requests for access of a shared resource received from threads to perform a process. The requests are registered into a list, in the order of priority or arrival. A method of performing queuing through software control by a master core and a method of performing queuing via an intervention circuit mounted on a shared resource are examples of queuing methods. Hereinafter, the former queuing method is referred to as a first queuing method and the latter queuing method is referred to as a second queuing method.

The cache method is applied to storage, etc. and is a method in which a cache memory is interposed between a CPU and a shared resource, such as a hard disk drive (HDD) or a flash memory, having a lower access speed than that of volatile memory. Thus, the CPU is able to access the shared resource at a throughput equal to that of the volatile memory. After being accessed by the CPU, the shared resource accesses the entity of the shared resource. The priority method is a method of adding priority to the threads to allow a higher-priority thread to preferentially access the shared resource.

For example, a technique employing the first queuing method includes setting a resource use flag and acquiring a thread for execution from the queue if another CPU is not accessing the shared resource. Such a technique has been disclosed that thereby avoids contention in the access of the shared resource and prevents CPU idling (see, for example, Japanese Laid-Open Patent Publication No. S62-290958).

A technique has also been disclosed that prevents an access contention by analyzing access of a shared resource and monitoring the access state at the time of dispatch (see, for example, Japanese Laid-Open Patent Publication No. 10-49389). A further technique has been disclosed that, when an access contention is about to occur, prevents the access contention by suspending a thread or spinning a thread according a schedule (see, for example, Japanese Laid-Open Patent Publication No. H6-12394).

In the conventional techniques, however, the second queuing method and the cache method have a problem of an increased cost consequent to requiring a special hardware mechanism. The second queuing method has a problem in that the CPU access is impeded when a rapid access unit, such as a DMA, is given preferential priority and performs a large volume of data access. The first queuing method has a problem in that although no special hardware mechanism is required, system throughput drops consequent to more time being consumed from the issuance of an access request until the execution of the process. The priority method has a problem of reduced performance when access is made by threads having the same priority.

The technique of Japanese Laid-Open Patent Publication No. H6-12394 also has a problem in that despite the access contention being obviated, performance drops consequent to the thread process being interrupted to suspend or spin the thread.

### SUMMARY

According to an aspect of an embodiment, a multi-core processor system includes a first core configured to detect a state where a first thread that is allocated to a first core among a plurality of cores and a second thread that is allocated to a second core different from the first core and among the cores access a common resource; calculate, upon detecting the state and based on a first cycle for the first thread to be allocated to the first core and a second cycle for the second thread to be allocated to the second core, a contention cycle for the first and the second threads to cause access contention for the resource; and select a thread allocated at a time before or after the contention cycle of a core to which a given thread that is any one among the first and the second threads is allocated at the calculated contention cycle; and a second core configured to switch the time at which the given thread is allocated and the time at which the selected thread is allocated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a hardware configuration of a multi-core processor system 100 according to an embodiment;

FIG. 2 is an explanatory diagram of a portion of hardware of the multi-core processor system 100, and executed software;

FIG. 3 is a functional diagram of the multi-core processor system 100;

FIG. 4 is an explanatory diagram of an overview of operations at the time of development and execution to execute a thread control process;

FIG. 5 is an explanatory diagram of an overview of a state where the multi-core processor system 100 is developed;

FIG. 6 is an explanatory diagram of an overview of thread dispatch;

FIGS. 7A, 7B, and 7C are explanatory diagrams of an overview of a method of switching the order of dispatch;

FIG. 8 is a timing chart when the thread control process is executed;

FIG. 9 is a timing chart when a thread is newly started up;

FIG. 10 depicts a flowchart of the thread control process executed when a thread is newly allocated;

FIGS. 11 and 12 depict flowcharts of contention cycle calculation processes executed in the thread control process; and

FIG. 13 depicts a flowchart of the thread control process executed when a dispatch time period or an interval of the multi-core processor system 100 is changed.

### DESCRIPTION OF EMBODIMENTS

A preferred embodiment of a multi-core processor system, a thread control method, and a thread control program according to the present invention will be described in detail with reference to the accompanying drawings.

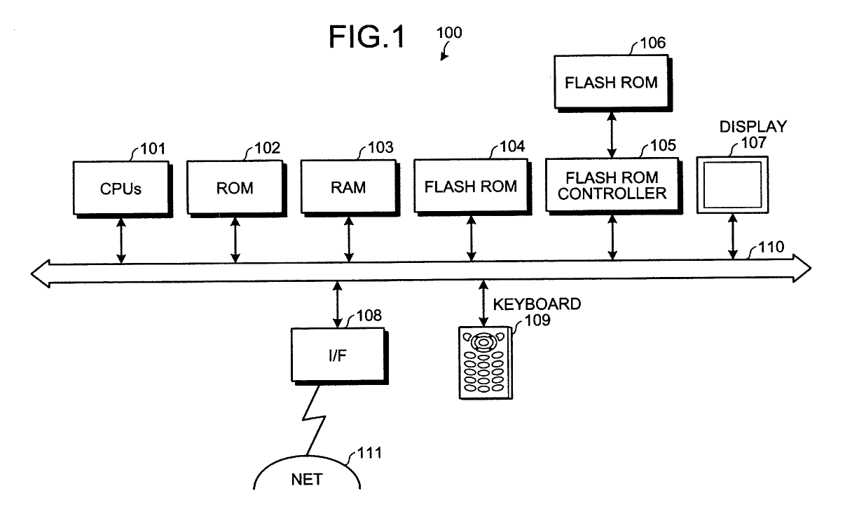

FIG. 1 is a block diagram of a hardware configuration of a multi-core processor system according to an embodiment. As depicted in FIG. 1, a multi-core processor system 100 includes multiple central processing units (CPUs) 101, read-only memory (ROM) 102, random access memory (RAM) 103, flash ROM 104, a flash ROM controller 105, and flash ROM 106. The multi-core processor system includes a display 107, an interface (I/F) 108, and a keyboard 109, as input/output devices for the user and other devices. The components of the multi-core system 100 are respectively connected by a bus 110.

The CPUs 101 govern overall control of the multi-core processor system 100. The CPUs 101 refer to CPUs that are single core processors connected in parallel. The CPUs 101 include CPUs #0 to #3. Further, the multi-core processor system 100 is a system of computers that include processors equipped with multiple cores. Provided that multiple cores are provided, implementation may be by a single processor equipped with multiple cores or a group of single-core processors in parallel. In the present embodiments, for the sake of simplicity in description, description will be given taking a group of single-core processors connected in parallel as an example.

The ROM 102 stores programs such as a boot program. The RAM 103 is used as a work area of the CPUs 101. The flash ROM 104 stores system software such as an operating system (OS), and application software. For example, when the OS is updated, the multi-core processor system 100 receives a new OS via the I/F 108 and updates the old OS that is stored in the flash ROM 104 with the received new OS.

The flash ROM controller 105, under the control of the CPUs 101, controls the reading and writing of data with respect to the flash ROM 106. The flash ROM 106 stores therein data written under control of the flash ROM controller 105. Examples of the data include image data and video data acquired by the user of the multi-core processor system through the I/F 108. A memory card, SD card and the like may be adopted as the flash ROM 106.

The display 107 displays, for example, data such as text, images, functional information, etc., in addition to a cursor, icons, and/or tool boxes. A thin-film-transistor (TFT) liquid crystal display and the like may be employed as the display 107.

The I/F 108 is connected to a network 111 such as a local area network (LAN), a wide area network (WAN), and the Internet through a communication line and is connected to other apparatuses through the network 111. The I/F 108 administers an internal interface with the network 111 and controls the input and output of data with respect to external apparatuses. For example, a modem or a LAN adaptor may be employed as the I/F 108.

The keyboard 109 includes, for example, keys for inputting letters, numerals, and various instructions and performs the input of data. Alternatively, a touch-panel-type input pad or numeric keypad, etc. may be adopted.

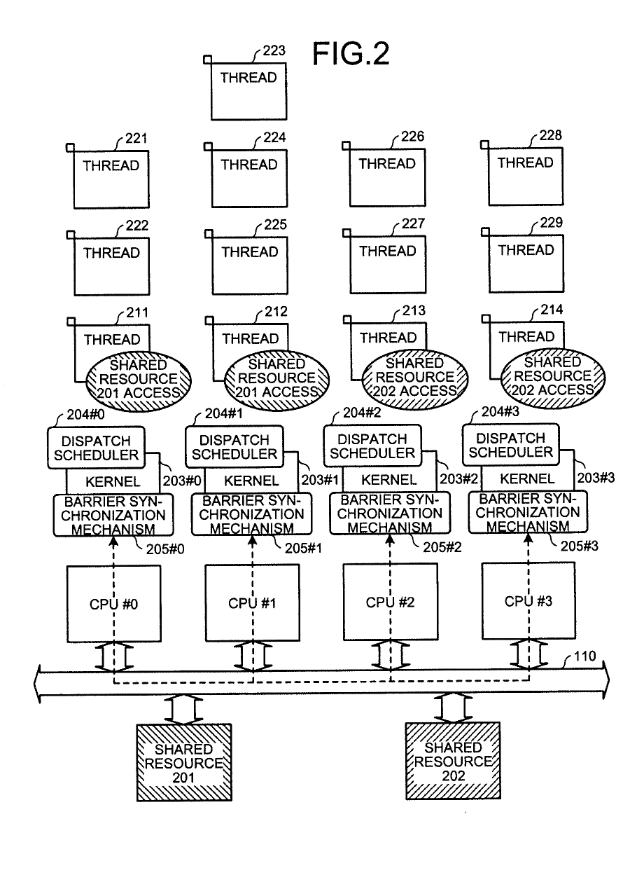

FIG. 2 is an explanatory diagram of a portion of hardware of the multi-core processor system 100, and executed software. The hardware depicted in FIG. 2 includes shared resources 201 and 202, and CPUs #0 to #3 that are included among the CPUs 101. The shared resources 201 and 202, and the CPUs #0 to #3 are connected respectively by a bus 110.

The shared resources 201 and 202 are devices accessed by the software. The devices include, for example, a camera device and an audio device connected to the I/F 108. A file system accessing the RAM 103, the flash ROM 104, etc. is included among resources. As described, the multi-core processor system 100 according to the embodiment needs no special buffer, queue, or hardware mechanism.

The software depicted in FIG. 2 includes a kernel 203, a dispatch scheduler 204, a barrier synchronization mechanism 205, and threads 211 to 214 and 221 to 229. The kernel 203, the dispatch scheduler 204, and the barrier synchronization mechanism 205 are each executed by the CPUs #0 to #3. Herein, “#0” to “#3” appended to reference numerals of software indicate that the software is to be executed by the corresponding CPU #0, #1, #2, or #3. For example, a kernel 203#0, a dispatch scheduler 204#0, and a barrier synchronization mechanism 205#0 are executed by the CPU #0.

The threads 211, 221, and 222 are executed by the CPU #0. The threads 212 and 223 to 225 are executed by the CPU #1. The threads 213, 226, and 227 are executed by the CPU #2. The threads 214, 228, and 229 are executed by the CPU #3.

The kernel 203 is a program that controls the CPUs. The kernel 203 is the core function of an OS and, for example, manages the resources of the multi-core processor system 100 to enable software, such as the threads, to access the hardware.

The dispatch scheduler 204 is a program that determines the threads to be allocated to the CPUs and that allocates the threads thereto. For example, the dispatch scheduler 204#0 determines the threads to be executed by the CPU #0 and stores in a context of the thread, register information such as a program counter of a currently allocated thread. The dispatch scheduler 204#0 acquires register information from the context of the determined thread, and sets the register information in the register of the CPU #0.

The barrier synchronization mechanism 205 is a mechanism that sets a point to establish synchronization; that, when the thread for which synchronization is to be established reaches the point for synchronization, is caused by the CPU to suspend the thread; and that, when all the threads reach a barrier point, causes the threads to restart.

For example, the case is assumed where the thread 211 is executed by the CPU #0 and the thread 212 is executed by the CPU #1. When the thread 211 reaches the point for synchronization to be established, the CPU #0 temporarily suspends the thread 211. Subsequently, when the thread 212 reaches the point for synchronization to be established, the CPU #1 causes the thread 212 to continue operation because all the threads have reached the point for synchronization to be established. The CPU #1 notifies the CPU #0 of cancellation of the suspension and the CPU #0 causes the thread 211 to restart. The barrier synchronization mechanism 205 may be implemented by the software or by hardware.

The threads 211 and 212 are threads that access the shared resource 201. The threads 213 and 214 are threads that access the shared resource 202. The threads 221 to 229 are threads that access none of the shared resources 201 and 202.

It is assumed that, for example, the shared resource 201 is a file system; the shared resource 202 is a camera device; the thread 211 is a character input thread; the thread 212 is a text editor thread; the thread 213 is a video chat thread; and the thread 214 is a camera thread that provides a function identical to that of a digital camera. The thread 211 uses the file system to access a kana-kanji conversion dictionary file. The thread 212 uses the file system to access a text file that is currently being edited. The thread 213 uses the camera device to capture, by a camera, image data for chatting. The thread 214 uses the camera device to operate the camera.

In this case, the threads 211 and 212 are periodically allocated to the CPUs #0 and #1 and therefore, when the threads 211 and 212 are allocated to the CPUs #0 and #1 at the same timing, contention arises for access of the file system. For example, a user inputs characters to be the thread 211 while the text editor thread, i.e., the thread 212, accesses the file system and consequently, an adverse effect is caused where, for example, the user may feel that input of the characters is not smoothly executed.

Although not depicted, when a download thread is present that accesses the file system as a storage destination for downloading, the processing speed of the download thread is reduced due to access contention each time the user inputs the characters to be the thread 211. As a result, an adverse effect is caused where the downloading is not completed within an estimated time period.

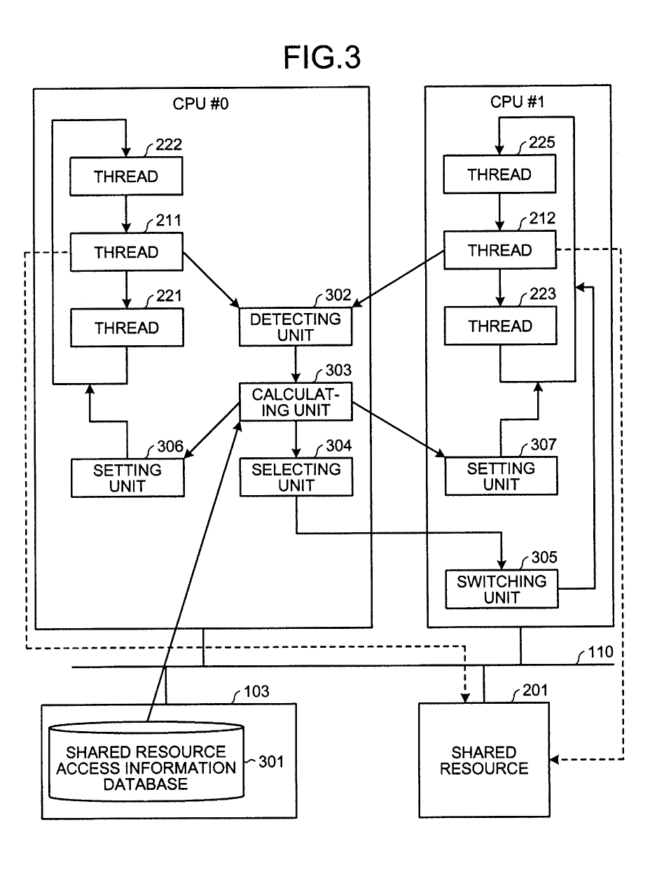

Functions of the multi-core processor system 100 will be described. FIG. 3 is a functional diagram of the multi-core processor system 100. The multi-core processor system 100 includes a detecting unit 302, a calculating unit 303, a selecting unit 304, a switching unit 305, and setting units 306 and 307. These functions (the detecting unit 302 to the setting unit 307) to be a controller are implemented by causing the CPUs 101 to execute programs stored in a storage device. The “storage device” is, for example, any one of the ROM 102, the RAM 103, and the flash ROMs 104 and 106 that are depicted in FIG. 1. These functions may be implemented by execution of the programs on another CPU through the I/F 108.

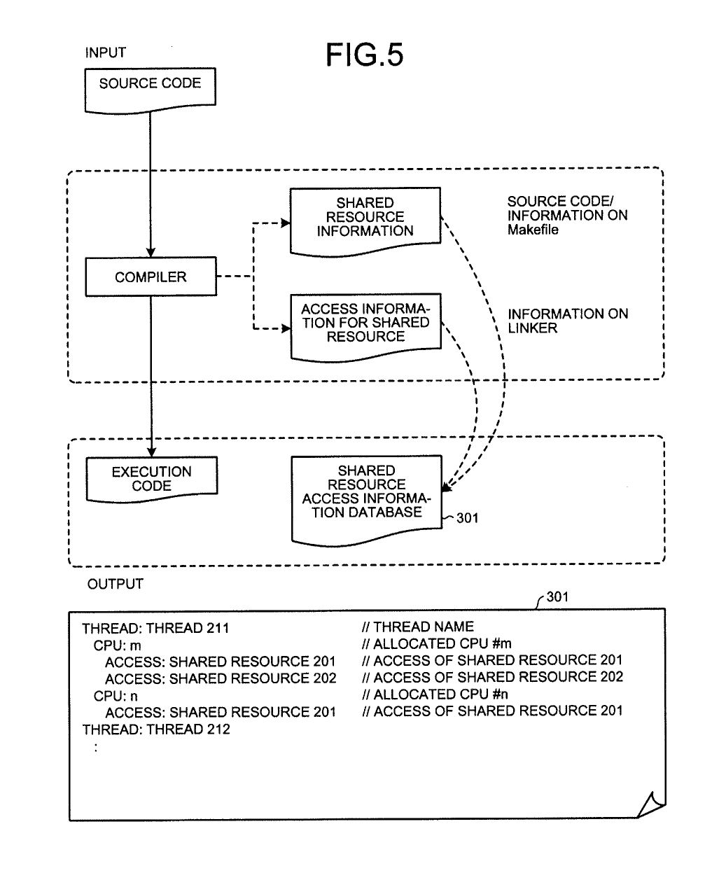

The multi-core processor system 100 can access a shared resource access information database 301 storing for each of the threads executed by the CPUs, access information for the shared resources. The shared resource access information database 301 will be described in detail with reference to FIG. 5.

In FIG. 3, the units from the detecting unit 302 to the selecting unit 304 and the setting unit 306 are depicted as functions of the CPU #0 and the switching unit 305 and the setting unit 307 are depicted as functions of the CPU #1. The switching unit 305 may be a function of the CPU #0 depending on the result from the selecting unit 304.

The detecting unit 302 has a function of detecting a state where a first thread allocated to a first core among plural cores and a second thread allocated to a second core different from the first core and among the cores access a common resource. For example, the detecting unit 302 detects a state where the thread 211 allocated, as the first thread, to the CPU #0 and the thread 212 allocated, as the second thread, to the CPU #1 respectively access the shared resource 201. The result of the detection is stored to a register or a cache memory of the CPU #0 or the RAM 103, etc.

When the detecting unit 302 detects a state where plural threads access a common resource, the calculating unit 303 acquires a first cycle at which the first thread is allocated to the first core and a second cycle at which the second thread is allocated to the second core. The calculating unit 303 also has a function of calculating based on the first and the second cycles, the contention cycle at which the first and the second threads cause access contention for the resource to occur. The calculating unit 303 may calculate the contention cycle by acquiring a common multiple of the first and the second cycles.

A “cycle allocated to the core” is a time period from the time when the thread is dispatched until the time when the thread is again dispatched. For example, in a case where the CPUs periodically dispatch the threads, when a thread is dispatched in one of six dispatching sessions and one dispatching session takes 10 [microseconds], the cycle allocated to the core is 6×10=60 [microseconds]. Hereinafter, the cycle allocated to the core will be referred to as “dispatch cycle”.

For example, the calculating unit 303 calculates based on the dispatch cycles of the threads 211 and 212, the contention cycle at which the threads 211 and 212 cause the access contention for the shared resource 201 to occur. The contention cycle may be acquired by multiplying the dispatch cycles of the threads 211 and 212 by each other as a method of calculating the contention cycle. For example, when the dispatch cycle of the thread 211 is 60 [microseconds] and that of the thread 212 is 40 [microseconds], the calculating unit 303 calculates the contention cycle to be 60×40=2,400 [microseconds]. When the dispatch cycles of the two threads are relatively prime, the calculating unit 303 can calculate all the contention cycles.

As another method of calculating the contention cycle, the calculating unit 303 may calculate the contention cycle by acquiring a common multiple of the dispatch cycles of the threads 211 and 212. When the dispatch cycle of the thread 211 is 60 [microseconds] and that of the thread 212 is 40 [microseconds], the calculating unit 303 may calculate the contention cycle to be the least common multiple LCM(60, 40), i.e., LCM(60, 40)=120 [microseconds].

The calculating unit 303 acquires the time at which the second thread is allocated to the second core for the last time before the time at which the first thread is allocated to the first core, and the first and the second cycles. The calculating unit 303 may continuously calculate the time at which the first access contention occurs after the time at which the first thread is allocated, as the contention cycle. Thereby, the calculating unit 303 calculates an offset time period, which is the period until the time of occurrence of the first access contention.

For example, the calculating unit 303 acquires the time at which the thread 212 is allocated to the CPU #1 for the last time before the time at which the thread 211 is allocated to the CPU #0, and the dispatch cycles of the threads 211 and 212. For simplification of description, the time at which the thread 211 is allocated is taken as the reference and the time at which the thread 212 is allocated to the CPU #1 for the last time is set to be −10 [microseconds]. It is assumed that the dispatch cycles of the threads 211 and 212 respectively are 30 and 50 [microseconds].

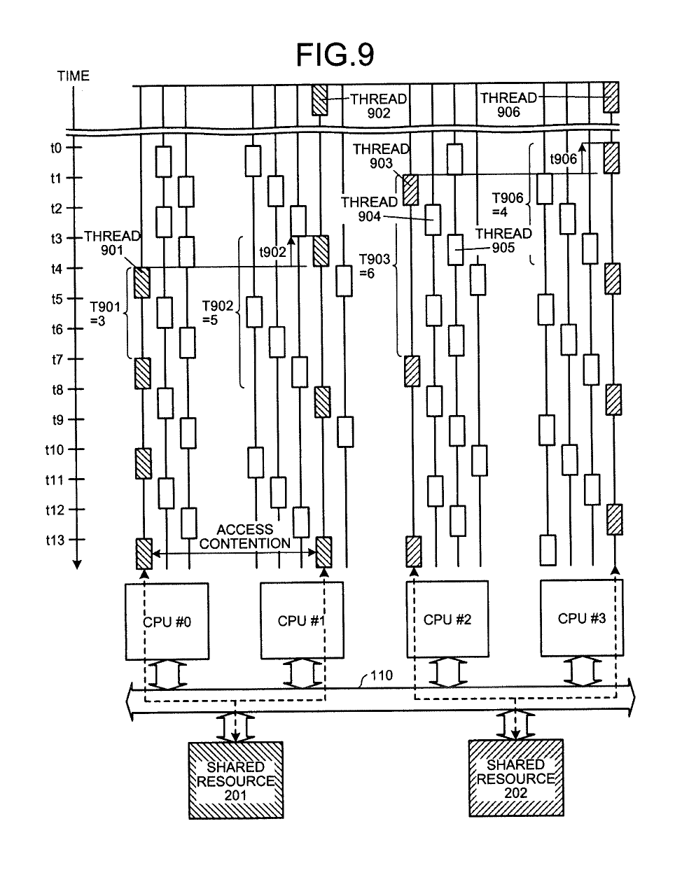

In this example, assuming that “a” is a non-negative integer, the thread 211 is allocated to the CPU #0 at 0, 30, 60, 90, 120, . . . , α·30 [microseconds]; and similarly, assuming that “β” is a non-negative integer, the thread 212 is allocated to the CPU #1 at −10, 40, 90, 140, . . . , (β·50−10) [microseconds]. In this case, the first access contention occurs at 90 [microseconds], which satisfies the condition that the time at which the access contention occurs=α·30=β·50−10 and where, α and β in the above example are α=3 and β=2. An example of a method of calculating α and β will be described with reference to FIG. 9. The calculated contention cycle is stored to the register or the cache memory of the CPU #0 or the RAM 103, etc.

The selecting unit 304 has a function of selecting a thread allocated at a time before or after the contention cycle of a core to which a given thread that is any one among the first and the second threads is allocated at the contention cycle calculated by the calculating unit 303. When the setting units 306 and 307 set the times to start the allocation of arbitrary threads to be the same, the selecting unit 304 may select a thread at the contention cycle calculated by the calculating unit 303.

For example, among the threads 211 and 212 that cause access contention to occur, the selecting unit 304 sets, as a given thread, the thread 211 and selects any one among the threads 222 and 221, which are allocated before and after the thread 211 is allocated. In this case, the switching unit 305 is a function of the CPU #0.

If, among the threads 211 and 212, the selecting unit 304 sets the thread 212, the selecting unit 304 selects any one among the threads 225 and 223, which are allocated before and after the thread 212 is allocated. In this case, the switching unit 305 is a function of the CPU #1. Information concerning the selected thread is stored to the register or the cache memory of the CPU #0 or the RAM 103, etc.

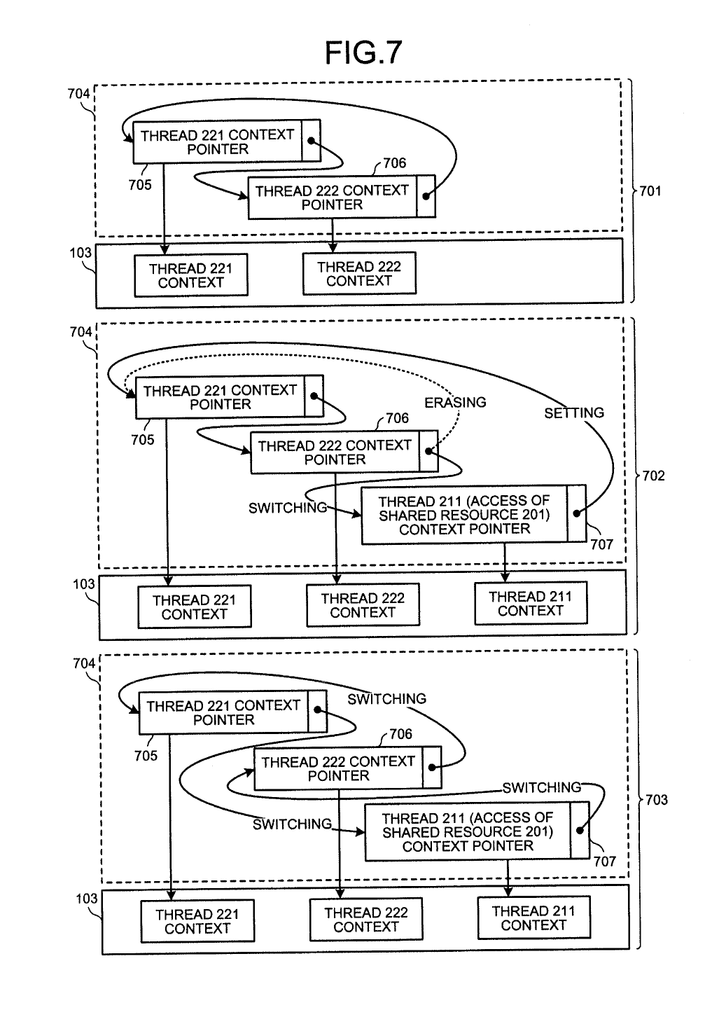

The switching unit 305 has a function of switching the time at which the given thread selected by the selecting unit 304 is allocated and the time at which the thread selected by the selecting unit 304 is allocated. For example, when the selecting unit 304 selects the thread 223, the switching unit 305 switches the time at which the thread 212 is allocated and the time at which the thread 223 is allocated. An example of a method of switching will be described with reference to FIG. 7. Information concerning the switching of the times at which the threads are allocated may be stored to the register or the cache memory of the CPU #1 or the RAM 103, etc.

The setting units 306 and 307 each have a function of setting the same time for the start of allocation of arbitrary threads that are to be allocated to the first and the second cores, when the calculating unit 303 calculates the contention cycle. For example, the setting units 306 and 307 set the times to start the allocation of the threads to the CPUs #0 and #1, to be the same time using the barrier synchronization mechanism 205. The information indicating that the times to start the allocation are set to be the same time may be stored to the register or the cache memory of the CPUs or the RAM 103, etc.

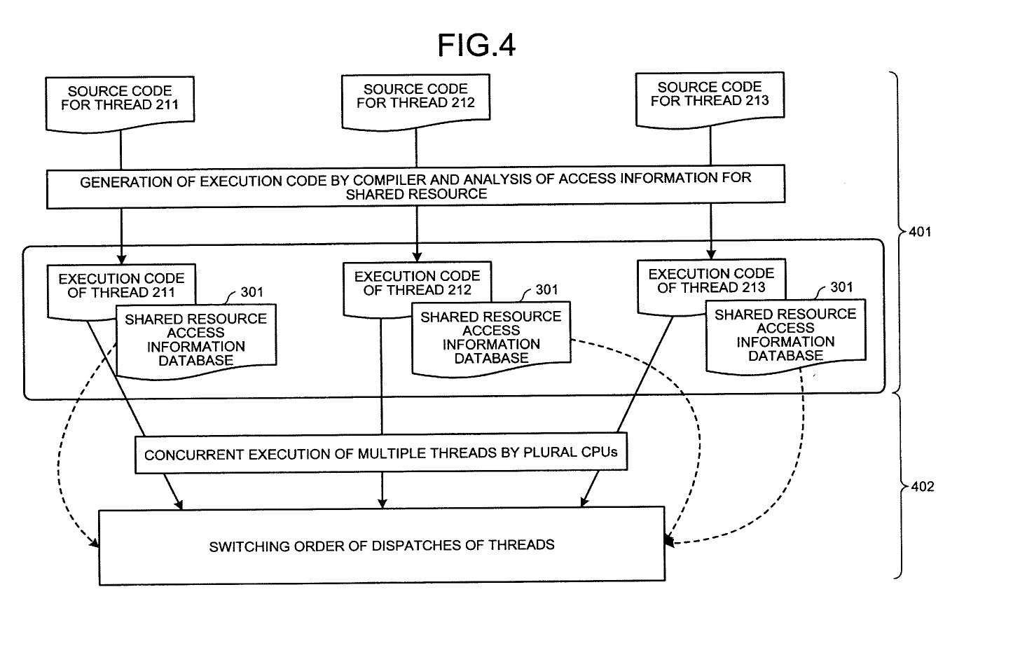

FIG. 4 is an explanatory diagram of an overview of operations at the time of development and execution to execute a thread control process. A process denoted by a reference numeral “401” is a process that is executed when the multi-core processor system 100 is developed. A process denoted by a reference numeral “402” is a process that is executed when the multi-core processor system 100 operates.

When the multi-core processor system 100 is developed, a compiler analyzes the generation of execution code and the access information for the shared resource from the source code for the thread 211, and outputs the execution code of the thread 211 and the shared resource access information database 301 that corresponds to the thread 211. Similarly, the compiler outputs the execution code of the thread 212 and the shared resource access information database 301 that corresponds to the thread 212 from the source code for the thread 212. Further, the compiler outputs the execution code of the thread 213 and the shared resource access information database 301 that corresponds to the thread 213 from the source code for the thread 213.

When the multi-core processor system 100 operates, the multi-core processor system 100 causes the CPUs to concurrently execute the multiple threads using the execution codes generated when the multi-core processor system 100 is developed. The multi-core processor system 100 refers to the shared resource access information database 301 and switches the dispatch order of the threads such that plural threads do not access the shared resource at the same time.

FIG. 5 is an explanatory diagram of an overview of a state where the multi-core processor system 100 is developed. The shared resource access information database 301 generated during the development will be described in detail with reference to FIG. 5.

The compiler generates from the source code input thereto, shared resource information and the access information for the shared resources. The shared resource information includes information concerning the shared resources of the multi-core processor system 100, and is generated from the input source code and information present on Makefile. The access information for the shared resources includes access information for the shared resources for each thread, and is generated by a linker that is among the functions of the compiler. The compiler generates the shared resource access information database 301 from the shared resource information and the access information for the shared resources.

The shared resource access information database 301 stores for each thread, access information of the shared resources. The shared resource access information database 301 includes a thread field, which is a primary item. The thread field includes a CPU field. The CPU field includes an access field.

The thread field stores the name of a thread such as “thread: thread 211”. The CPU field stores the CPU number (CPU No.) of the CPU to which the thread is allocated and, for example, when a thread is allocated to a CPU #m to be the m-th CPU, the CPU No. is set to be, for example, “CPU: m”. The CPU field is dynamically determined by the dispatch scheduler 204 when the multi-core processor system 100 executes. The access field stores the name of the shared resource accessed by the allocated thread and the shared resource name is, for example, “access: shared resource 201”

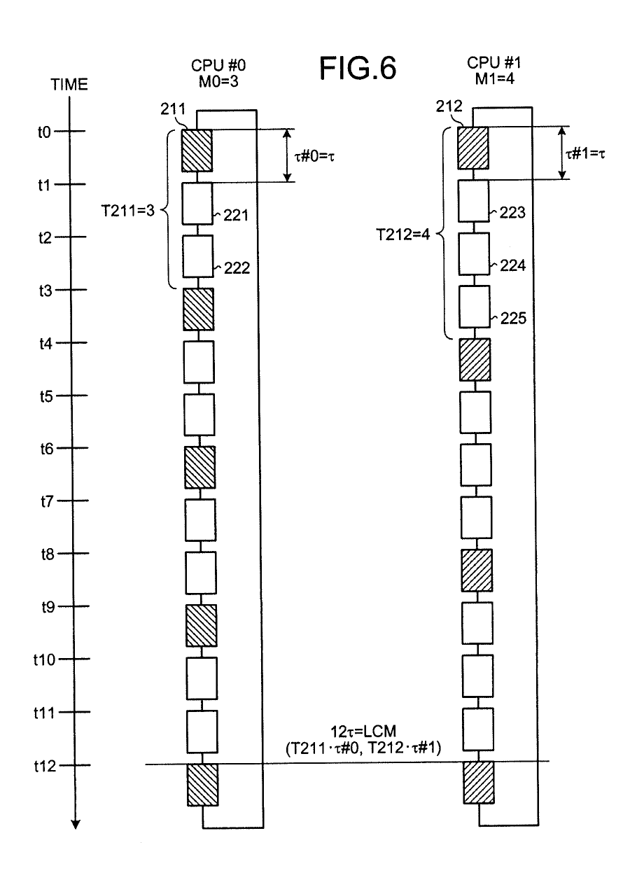

FIG. 6 is an explanatory diagram of an overview of thread dispatch. The thread allocated to a CPU is periodically executed by the dispatch scheduler 204. In the example of FIG. 6, as depicted in FIG. 2, the number M0 of threads under execution by the CPU #0 is M0=3 and, for example, the CPU #0 executes the threads 211, 221, and 222. The number M1 of threads under execution by the CPU #1 is M1=4 and the CPU #1 executes the threads 212 and 223 to 225. The threads 211 and 212 access the shared resource 201. The threads 221 to 225 are system threads supervised by the OS and are not involved in shared resource contention.

The dispatch scheduler 204 allocates threads to the CPUs in a time-division scheme. Representing the time period to be a unit time period in this case as “dispatch time period τ”, in the example of FIG. 6, it is assumed that the dispatch time period τ#0 of the CPU #0 and the dispatch time period τ#1 of the CPU #1 are τ#0=τ#1=τ. An interval indicating the number of time units at which a thread is allocated to a CPU is denoted by “T”. The value of the interval T becomes smaller the higher the priority of the thread is because the thread is allocated to the CPU more frequently when the priority is higher. As described, the interval T is inversely related to the priority. In the example of FIG. 6, an interval T211 of the thread 211 is T211=3 and an interval T212 of the thread 212 is T212=4.

In the example of the multi-core processor system 100 during operation, the multi-core processor system 100 executes M threads, e.g., M=about 50 to 100. The dispatch scheduler 204 allocates the thread for the dispatch time period τ that is set by the OS, etc., where τ=1 to 100 [microseconds]. When the dispatch time period is several microseconds, the multi-core processor system 100 is referred to as a “real-time system”.

For example, a case is assumed where the clock numbers of the cores of the multi-core processor system 100 are all identical; the interval T and the thread number M of the thread having the lowest priority are T=M=50; and the dispatch time period τ is τ=50 [microseconds]. In this case, the thread having the lowest priority is executed for 50 [microseconds] once every 2,500 [microseconds]; and for the thread having the highest priority, T is T=2 and the thread is executed every 50 [microseconds] for 50 [microseconds].

The dispatch cycle at which the thread is dispatched as described with reference to FIG. 3 can be calculated by multiplying the interval T and the dispatch time period τ of the thread. In the example above, the dispatch time period of the thread having the lowest priority is 50×50=2,500 [microseconds] and that of the thread having the highest priority is 2×50=100 [microseconds].

In the example of FIG. 6, the dispatch scheduler 204#0 causes the thread 211 to be executed by the CPU #0 for the time period of τ#0 at times t0, t3, t6, t9, and t12, respectively; and the dispatch scheduler 204#1 causes the thread 212 to be executed by the CPU #1 for the time period of τ#1 at times t0, t4, t8, and t12, respectively.

In this case, the CPU #0 calculates the least common multiple LCM(T211·τ#0, T212·τ#1)=12τ of the dispatch cycle T211·τ#0 of the thread 211 and the dispatch cycle T212·τ#1. The threads 211 and 212 are executed at the time t12 obtained by adding 12τ that is the calculated value to the time t0. Consequently, access contention for the shared resource 201 occurs. The access contention also occurs at the time obtained by further adding the LCM(T211·τ#0, T212·τ#1)=12τ to the time t12. In this manner, in the example of FIG. 6, access contention occurs at contention cycles, where one cycle is the LCM(T211·τ#0, T212·τ#1).

In generalizing the example of FIG. 6, it is assumed for the multi-core processor system 100 that intervals Tx and Ty are of two threads that access a common resource, and dispatch time periods τm and τn are of CPUs #m and #n to which the two threads are allocated. In this case, the multi-core processor system 100 can calculate the contention cycle at which access contention occurs by acquiring the LCM(Txτm, Tyτn).

FIGS. 7A, 7B, and 7C are explanatory diagrams of an overview of a method of switching the order of dispatch. FIGS. 7A, 7B, and 7C depict a method of switching the order of dispatch as a method of preventing access contention, used when the contention cycle is calculated as depicted in FIG. 6. FIG. 7A depicts the state of dispatch data 704 when threads not involved in access contention are executed. FIG. 7B depicts transition from the state of the dispatch data 704 depicted in FIG. 7A to a state where threads causing access contention to occur are executed. FIG. 7C depicts transition from the state of the dispatch data 704 depicted in FIG. 7B to a state where the dispatch order of the threads causing the access contention to occur is changed.

FIG. 7A depicts the state of the dispatch data 704 when the threads 221 and 222 are executed as a state where the threads not involved in access contention are executed. The dispatch data 704 is accessed by the dispatch scheduler 204 and stores pointers to the threads under execution.

The structure of the dispatch data 704 is a single-directional list formed by connecting the threads under execution to each other in a single direction. For example, the elements of the dispatch data 704 each include a data unit and a pointer unit. The data unit stores a pointer to a thread context. The pointer unit stores a pointer to the next element. The pointer unit in the last element stores a pointer to the element at the head.

For example, the dispatch data 704 in the explanatory diagram denoted by the reference numeral “701” includes elements 705 and 706. A data unit of the element 705 stores a pointer to a context of the thread 221 and the pointer unit stores a pointer to the element 706. A data unit of the element 706 stores a pointer to a context of the thread 222 and the pointer unit thereof stores a pointer to the element 705.

For example, a case is assumed where the thread 221 is under execution by the CPU #0 and the next thread is allocated. The dispatch scheduler 204#0 retains a pointer to an element of the thread under execution and acquires the element 705 from the pointer. The dispatch scheduler 204#0 acquires the element 706 from the pointer unit of the element 705. The CPU #0 in the state depicted in FIG. 7A executes the threads in order of the thread 221→thread 222→thread 221 . . . .

FIG. 7B depicts transition from the state of the dispatch data 704 depicted in FIG. 7A to a state where the thread 211 is newly allocated to the CPU #0 as a case where threads causing access contention to occur are executed. When the thread 211 is to be allocated subsequent to the thread 222, the dispatch scheduler 204#0 first secures an element 707 in the dispatch data 704 and stores in the data unit of the element 707, a pointer to the context of the thread 211.

The dispatch scheduler 204#0 erases the pointer to the element 705, stored in the pointer unit of the element 706 and replaces the erased pointer with a pointer to the element 707, as operations for the pointer unit. The dispatch scheduler 204#0 sets a pointer to the element 705 in the pointer unit of the element 707. Thereby, the CPU #0 in the state depicted in FIG. 7B executes the threads in order of the thread 221→thread 222→thread 211→thread 221→thread 222 . . . .

FIG. 7C depicts transition from the state of the dispatch data 704 depicted in FIG. 7B to a where the allocation order of the threads 211 and 221 is switched as a case where the dispatch order of the threads causing access contention to occur is changed. The timing at which the switching is executed is set to be a timing at which allocation of the thread 211 is attempted when the CPU #0 completes the allocation of the threads 221 to 222 in the state depicted in FIG. 7B.

After the allocation of the thread 222, the dispatch scheduler 204#0 replaces in the pointer unit of the element 706, the pointer to the element 707 with a pointer to the element 705 to allocate the thread 221 instead of the thread 211. After the allocation of the thread 221, the dispatch scheduler 204#0 replaces in the pointer unit of the element 705, the pointer to the element 706 with a pointer to the element 707 to allocate the thread 211. After the allocation of the thread 211, the dispatch scheduler 204#0 replaces in the pointer unit of the element 707, the pointer to the element 705 with a pointer to the element 706 to allocate the thread 222.

Thus, the CPU #0 in the state depicted in FIG. 7C executes the threads in order of the thread 221→thread 222, switching occurs at this time, to the thread 221→thread 211→thread 222, and so on. In the example depicted in FIGS. 7A, 7B, and 7C, the dispatch scheduler 204#0 switches the allocation order of the two threads that are adjacent to each other in the temporal sequence. However, when four or more threads are executed, the dispatch scheduler 204#0 may switch the allocation order of the threads that are away from each other in the temporal sequence.

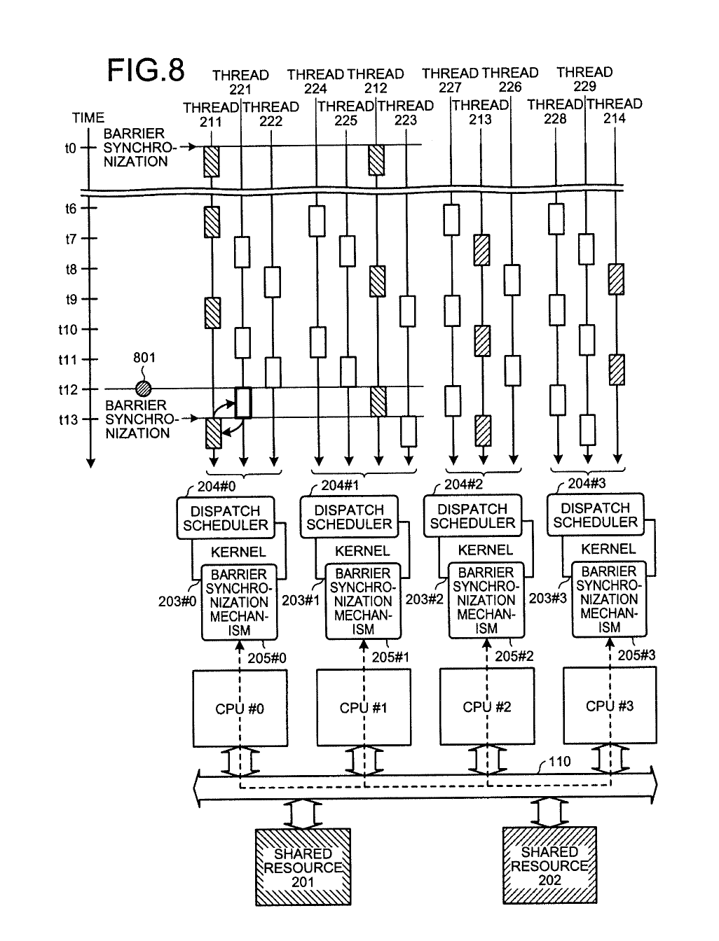

FIG. 8 is a timing chart when the thread control process is executed. FIG. 8 depicts the timing chart acquired when the order of dispatch in the temporal sequence depicted in FIG. 7 is switched in the case where the access contention occurs at the timings depicted in FIG. 6. In FIG. 8 and FIG. 9 that will be described later, for simplification of the description, the dispatch time periods τ are all equal and the time intervals between each two times of the times t0, t1, . . . , tn are all equal that are τ.

At the time t0, upon detecting, from the shared resource access information database 301, that the threads 211 and 212 access the shared resource 201, the CPU #0 calculates the contention cycle and sets a marking on each contention cycle. In the example of FIG. 8, the CPU #0 sets a marking 801 at the time t12. As an example of a method of setting the marking, the CPU #0 secures a counter to be a variable of the dispatch scheduler 204#0 and sets “12” in the counter. The CPU #0 may determine that the time when the threads are allocated for the number of the set counters is the time at which the marking is set.

The CPU setting the marking 801 may be any one of the CPUs allocating the threads that cause access contention to occur. For example, the CPU #0 may set the marking 801 on the CPU #0, i.e., the CPU whose CPU No. is small. When the CPU #0 detects that three or more threads cause access contention to occur at the same time, the CPU #0 may set the marking 801 on another CPU that remains after excluding any arbitrary one of the CPUs that allocate the detected threads. For example, when the CPUs #0 to #2 execute the threads that cause access contention to occur, the CPU #0 may set the marking on each of the CPUs #0 and #1.

After the marking 801 is set, to set the timings to execute the threads to be same as each other, the CPU #0 causes the CPUs #0 and #1 to execute barrier synchronization using the barrier synchronization mechanisms 205#0 and 205#1.

At the time t12 (the time at which the marking 801 is set), the CPU #0 switches the time at which the thread 211 is allocated and the time at which the thread 221 is allocated. For example, the CPU #0 switches the time at which the thread 211 is allocated, from the time t12 to the time t13 and switches the time at which the thread 221 is allocated, from the time t13 to the time t12. At the time t13 (the time for the allocation of the thread 221 to come to an end), the CPU #0 causes the CPUs #0 and #1 to execute the barrier synchronization. Thereby, in the subsequent contention cycle, the timings to execute the threads can also be set to be identical. Consequent to the execution of the barrier synchronization at the time t13, the CPU #0 does not allocate the thread 211 until the CPU #1 completes the allocation of the thread 212. As a result, the access contention can be avoided.

The CPU #2 executes at the times t7, t10, and t13, the thread 213 that accesses the shared resource 202. The CPU #3 executes at the times t8 and t11, the thread 214 that accesses the shared resource 202. The intervals T 213 and T214 are T213=T214=3 and therefore, the cycles to execute the threads are identical. When the start up timings differ, no access contention occurs and therefore, no marking is set.

FIG. 9 is a timing chart when a thread is newly started up. In FIG. 8, the contention cycle is calculated for a case where the start up timings are identical among the threads 211 and 212 at the time t0. In FIG. 9, the offset time until the time of the occurrence of the first access contention will be described for a case where a thread accessing a specific shared resource is already allocated to a CPU when another thread accessing the same shared resource is allocated to another CPU.

The state of the multi-core processor system 100 of FIG. 9 is different from the state to execute the software depicted in FIG. 2. For example, the number M0 of threads of the CPU #0 until the time t3 is M0=2 and, at the time t4, a thread 901 accessing the shared resource 201 is further allocated to the CPU #0 as a new thread. As a result, the number M0 of threads becomes M0=3. An interval T901 of the thread 901 become “3” and the thread 901 is allocated at the times t7, t10, and t13 after the time t4.

The number M1 of threads of the CPU #1 is M1=5 and the CPU #1 allocates at the time t3, a thread 902 accessing the shared resource 201. An interval T902 of the thread 902 is “5” and the thread 902 is allocated at the times t8 and t13 after the time t3.

The number M2 of threads of the CPU #2 at the time t0 is M2=3 and the priority of each of threads 904 and 905 is high. At the time t1, a thread 903 accessing the shared resource 202 is allocated to the CPU #2 as a new thread. As a result, the number M2 of threads becomes M2=4. An interval T903 of the thread 903 become “6” and the thread 903 is allocated at the times t7 and t13 after the time t1.

The number M3 of threads of the CPU #3 is M3=4 and at the time t0, a thread 906 accessing the shared resource 202 is allocated to the CPU #3. An interval T906 of the thread 906 is “4” and the thread 906 is allocated at the times t4, t8, and t12 after the time t0.

A method will be described of calculating the contention cycle generated by the threads 901 and 902 accessing the shared resource 201 and executed by the CPU #0, using the timing chart depicted in FIG. 9. A method will be described of calculating the contention cycle generated by the threads 903 and 906 that access the shared resource 202 and are executed by the CPU #2.

The CPU #0 first acquires a time period “t” from the time at which the allocation of the thread 901 is started to the time when another thread causing access contention to occur is allocated for the last time. In the example of FIG. 9, the time at which the thread 902 is allocated for the last time is t3 and therefore, the CPU #0 acquires a time period t902 from the time t4 to the time when the thread 902 is allocated for the last time, that is t902=−τ.

Assuming that α and β each are a non-negative integer, the time at which the access contention occurs relative to the time t4 satisfies Eq. (1) below.

time of access contention=T901·τα==T902·τ·β+t902 (1)

Acquiring the combination of the smallest α and the smallest β for Eq. (1) enables calculation of the time at which the access contention occurs. Eq. (1) can be expressed by a congruence equation that is Eq. (2) below.

T902·τ·β=−t902(mod T901·τ) (2)

The CPU #0 substitutes T901=3, T902=5, and t902=−τ into Eq. (2), divides the result by τ, and acquires Eq. (3) below.

5β1|1(mod 3) (3)

Eq. (3) to be a primary congruence equation can be solved, for example, as follows. In Eq. (3), because 5−3=2, the CPU #0 acquires Eq. (4) below.

2β≡1(mod 3) (4)

According to the nature of the congruence equation, the CPU #0 multiplies Eq. (4) by two and thereby, acquires Eq. (5) below.

4β≡2(mod 3) (5)

The CPU #0 subtracts Eq. (5) from Eq. (4) and thereby, acquires Eq. (6).

β≡−1(mod 3) (6)

From Eq. (6), β is acquired that is β=3N−1 (N=0, 1, 2, 3, 4, . . . ). However, β is a non-negative integer and therefore, the smallest β is β=2 and calculation of α corresponding thereto from Eq. (1) gives α that is α=3. Therefore, the time at which the access contention occurs is the time t13 acquired by adding 9τ to the time t4. The time at which the next access contention occurs is the time acquired by adding the LCM(T901·τ, T902·τ) to the time t13.

Many methods of solving Eq. (3) are known and, for example, the CPU #0 may calculate β using a Gaussian calculation method. The CPU #0 may calculate an inverse element to calculate β as another solution method. For example, an inverse element of five is acquired to be two using a modulus that is three and the both sides of Eq. (3) are multiplied by the inverse element that is two. Thereby, the solution is calculated. For example, the inverse element can be calculated using the extended Euclidean mutual division as a method of calculating the inverse element.

A method of calculating the contention cycle will be described that is generated by the threads 903 and 906 accessing the shared resource 202, the method being executed by the CPU #2. The CPU #2 acquires the time period t from the time at which the allocation of the thread 903 is started to the time when another thread causing access contention is allocated for the last time. In the example of FIG. 9, the time at which the thread 906 is allocated for the last time is the time t0 and therefore, the CPU #0 acquires the time period t906 from the time t1 to the time when the thread 902 is allocated for the last time, that is t906=−τ.

As to the time at which the access contention occurs, the CPU #2 acquires Eq. (7) below by applying Eq. (1).

time at which access contention

occurs=T903·τ·α=T906·τ·β+t906 (7)

Execution of the procedure executed for Eqs. (2) and (3), for Eq. (7) gives Eq. (8) below.

4β≡1(mod 6) (8)

Eq. (8) to be a primary congruence equation has no solution for β. Because, when any solution is present for β, (4β−1) is a multiple of six and is an even number according to the definition of the congruence equation while (4β−1) is an odd number because 4β is an even number and therefore, inconsistency is present. When no solution is present, no access contention occurs and therefore, the CPU #0 executes no marking.

Whether a solution x exists for a primary congruence equation ax≡b(mod m) is equivalent to a condition that “b” is dividable by the greatest common divisor GCD(a, m) of “a” and “m”. For example, in the example of Eq. (3), from a=5, b=1, and m=3, the GCD(5, 3) is GCD(5, 3)=1, therefore, b that is b=1 is divisible by the GCD(5, 3) and therefore, a solution is present. In the example of Eq. (8), from a=4, b=1, and m=6, the GCD(4, 6) is GCD(4, 6)=2, therefore, b that is b=1 is not divisible by the GCD(4, 6) and therefore, no solution exists. In this manner, the CPU #0 may determine whether access contention occurs, by determining based on the above condition whether the above solution exists, when the CPU #0 acquires the primary congruence equations like Eqs. (3) and (8) from Eq. (1) by substituting the variables in Eq. (1).

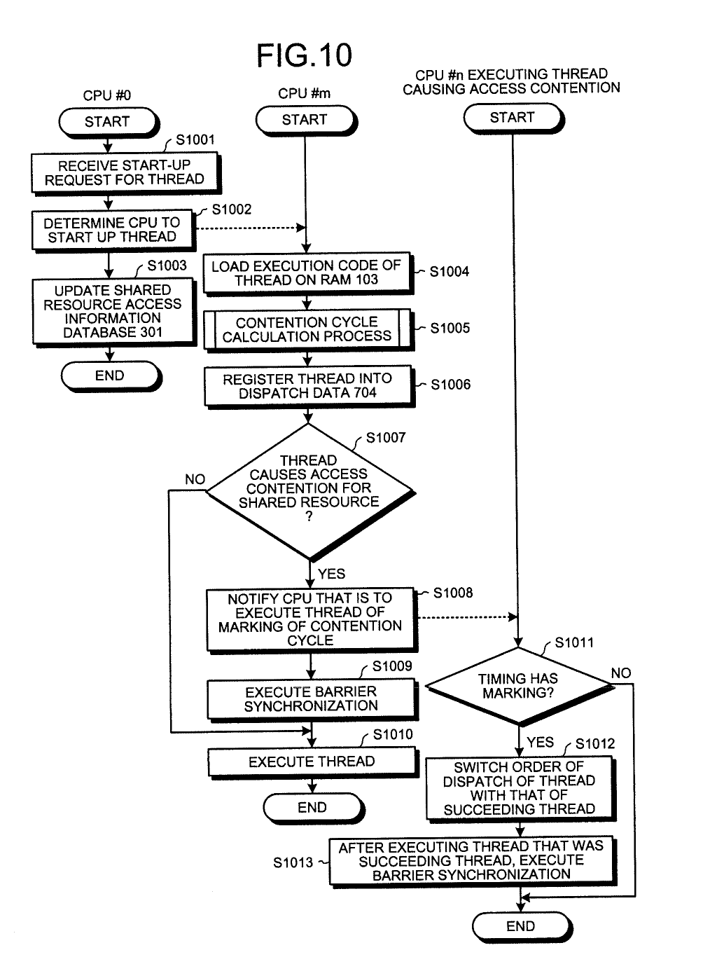

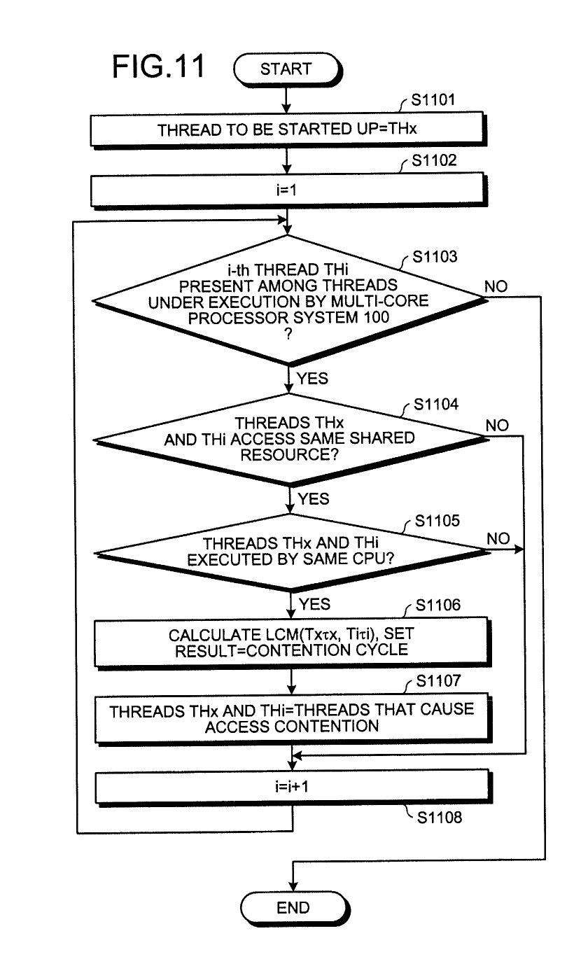

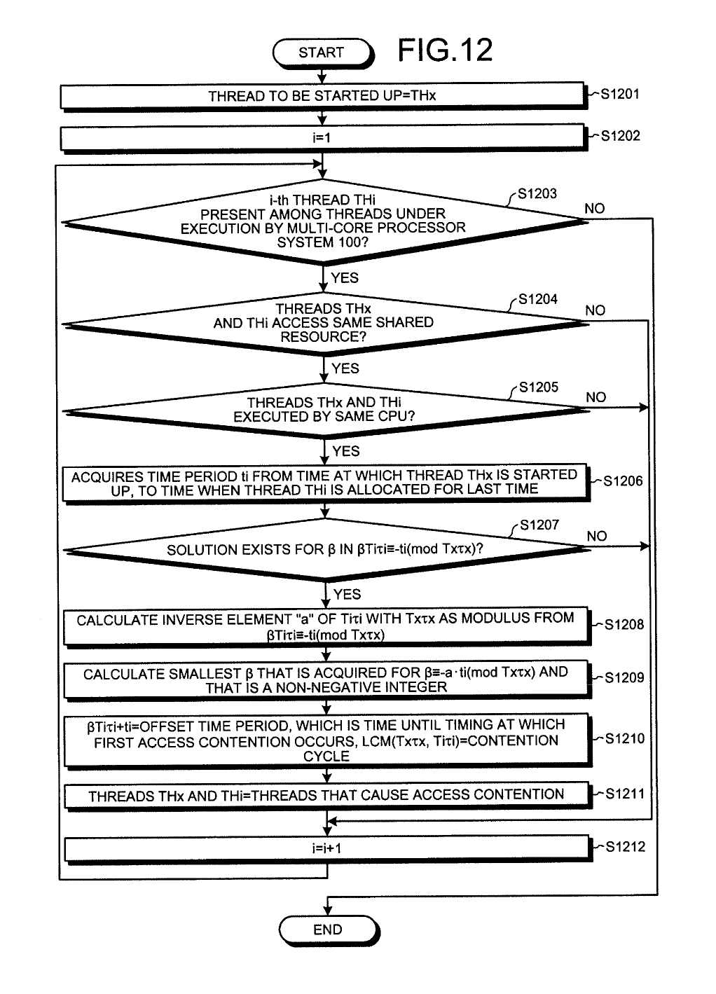

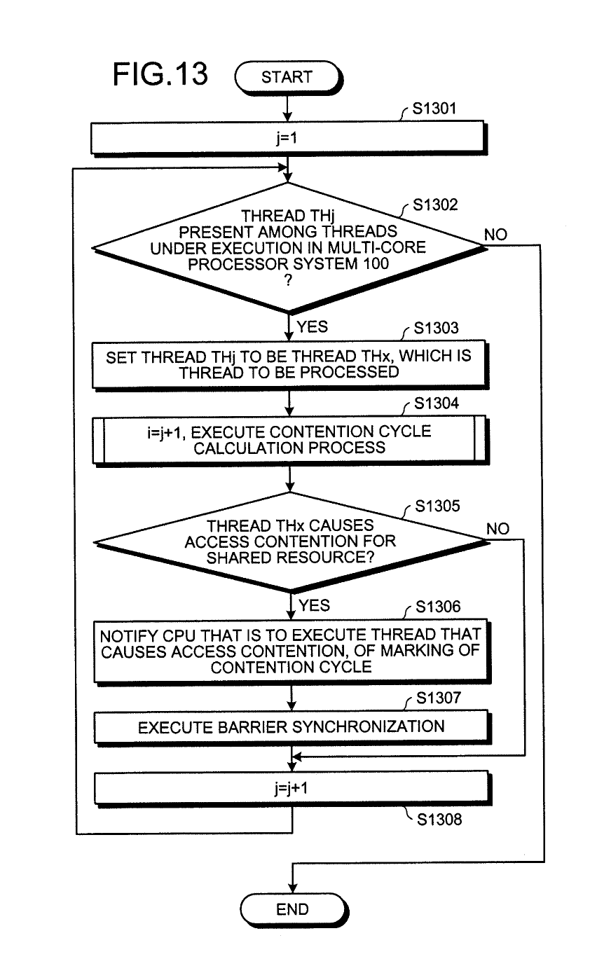

To realize the timing charts depicted in FIGS. 8 and 9, the multi-core processor system 100 executes the thread control process depicted in FIGS. 10 to 13 to avoid access contention. FIG. 10 depicts a flowchart of the thread control process executed when a thread is newly allocated. FIGS. 11 and 12 depict flowcharts of contention cycle calculation processes executed in the thread control process. FIG. 13 depicts a flowchart of the thread control process executed when the dispatch time period τ or the interval T of the multi-core processor system 100 is changed.

The case to be applied with the thread control process depicted in FIG. 3 is a case, for example, where the dispatch time period τ of a specific CPU is changed and recalculation is necessary for the contention cycles for all the threads. A case where the dispatch time period τ is changed is a case, for example, where the priority of the thread under execution is changed by the OS or the thread itself.

FIG. 10 is a flowchart of the thread control process. The CPU #0 receives a start-up request for a thread via user operation (step S1001). After receiving the start-up request, the CPU #0 determines a CPU to start up the thread by the dispatch scheduler 204#0 (step S1002) and notifies the determined CPU of the thread information. It is assumed in the example of FIG. 10 that a CPU #m to be the m-th CPU starts up the thread.

After determining the CPU to start up the thread, the CPU #0 updates the shared resource access information database 301 (step S1003) and causes the thread control process executed by the CPU #0 to come to an end. As an example of updating of the shared resource access information database 301, the CPU #0 enters into the CPU field of the shared resource access information database 301, the CPU No. of the CPU to start up the thread.

The CPU #m receives notification concerning the thread information and loads the execution code of the thread to be started up thereby on the RAM 103 (step S1004). After loading the execution code, the CPU #m executes the contention cycle calculation process (step S1005). After executing this process, the CPU #m registers into the dispatch data 704, the thread to be started up (step S1006). After registering the thread, the CPU #m determines based on the result of the contention cycle calculation process, whether the thread to be started up causes access contention for the shared resource to occur (step S1007).

If the CPU #m determines that the thread to be started up causes access contention to occur (step S1007: YES), the CPU #m notifies the CPU that is to execute the thread that causes access contention to occur, of the marking of the contention cycle (step S1008). At least two or more CPUs are present, each to execute the thread that causes access contention to occur and therefore, the CPU #m notifies the CPU(s) remaining after excluding one arbitrary CPU among such CPUs, of the marking. It is assumed in the example of FIG. 10 that a CPU #m notifies a CPU #n as the n-th CPU, of the marking.

For example, when the CPU #m to execute the thread to be started up is the CPU #0 and the CPUs each to execute threads that causes access contention to occur are the CPUs #0 and #1, it is assumed that either one of the CPUs #0 and #1 is the CPU #n, and the CPU #n is notified of the marking. If the CPUs each to execute threads that causes access contention to occur are the CPUs #0 to #2, the CPU #0 may notify, for example, the CPUs #0 and #1 of the marking.

After giving notification of the marking, the CPU #m executes the barrier synchronization using the barrier synchronization mechanism 205 (step S1009). The barrier synchronization is issued to each of the CPUs to execute the thread that causes access contention to occur. If the CPU #m determines that the thread to be started up causes no access contention to occur (step S1007: NO) or after the process at step S1009 comes to an end, the CPU #m executes the thread to be started up (step S1010) and causes the thread control process executed by the CPU #m to come to an end.

The CPU #n receives the notification concerning the marking and when dispatching the thread, the CPU #n determines whether the timing has the marking set thereon (step S1011). If the CPU #n determines that the timing has the marking set thereon (step S1011: YES), the CPU #n switches the order of the dispatch of the thread with that of the succeeding thread (step S1012). After switching the dispatches, the CPU #n executes the thread that is the succeeding thread before the switching and thereafter, executes the barrier synchronization (step S1013). After causing the process at step S1013 to come to an end, or when the CPU #n determines that the timing is not the timing that has the marking set thereon (step S1011: NO), the CPU #n causes the thread control process executed by the CPU #m to come to an end.

The CPU #n switches the order of the dispatch of the thread with that of the succeeding thread at step S1012. However, the CPU #n may switch the dispatch of the threads whose dispatch time periods are away from each other by one or more unit(s). In particular, the switching of the threads whose dispatch time periods are away from each other by one or more unit(s) is effective when, at step S1008, three or more CPUs are present respectively executing threads that cause access contention to occur and two or more of the CPUs are notified of the marking. In this case, the first CPU among the CPUs receiving the notification switches the order of the dispatch of the thread with that of a thread immediately after the thread and the second CPU switches the order of the dispatch of the thread with that of a thread whose dispatch time period is away from that of the thread by one unit.

When three CPUs are present respectively executing threads that cause access contention to occur and the two CPUs each notified of the marking respectively switch the order of the dispatch of the thread with that of a succeeding thread, access contention occurs at the time acquired by adding the dispatch time period to the contention cycle. However, by switching the dispatch of the thread with that of a thread whose dispatch time period is away from the dispatch time period of the thread, the access contention for the shared resource can be prevented at: the time of the contention cycle; the time acquired by adding the dispatch time period to the contention cycle; and the time acquired by adding two units of the dispatch time period to the contention cycle, respectively.

In the flowchart of FIG. 10, the CPU #n switches the order of the dispatch of the thread with that of a succeeding thread. However, the CPU #n may switch the order of the dispatch of the thread with that of a preceding thread. If the CPU #n switches the order of the dispatch of the thread with that of a preceding thread, for example, at step S1011, the CPU #n determines whether the dispatch time period is earlier by one unit than the timing with the marking set thereon. If the CPU #n determines that the dispatch time period is earlier by one unit, the CPU #n can switch the order of dispatch of the thread with that of the preceding thread by switching the time of the allocation of the thread that is to be allocated and the time of the allocation of the thread that causes access contention to occur and that is allocated after one unit.

FIG. 11 is a flowchart of a contention cycle calculation process. The contention cycle calculation process is executed by a CPU that executes the thread to be started up. To maintain the consistency with the description made with reference to FIG. 10, the description with reference to FIG. 11 will be made assuming that the CPU #m executes the contention cycle calculation process.

The CPU #m sets the thread to be started up, to be “THx” (step S1101) and sets a variable “i” to be one (step S1102). After this setting, the CPU #m determines whether the i-th thread THi is present among the threads under execution by the multi-core processor system 100 (step S1103). If the CPU #m determines that the thread THi is present (step S1103: YES), the CPU #m determines whether the threads THx and THi access the same shared resource (step S1104). If the CPU #m determines that the threads THx and THi access the same shared resource (step S1104: YES), the CPU #m determines whether the threads THx and THi are executed by the same CPU (step S1105).

If the CPU #m determines that the threads THx and THi are executed by the same CPU (step S1105: YES), the CPU #m calculates the LCM(Txτx, Tiτi) and sets the calculation result to be the contention cycle (step S1106). “Tx” and “τx” respectively mean the interval Tx of the thread THx and the dispatch time period τx thereof. “Ti” and “τi” respectively mean the interval Ti of the thread THi and the dispatch time period τi thereof. After setting the contention cycle, the CPU #m sets the threads THx and THi to be the threads that cause access contention to occur (step S1107), increments the variable i (step S1108), and proceeds to the process at step S1103.

If the CPU #m determines that the threads THx and THi do not access the same shared resource (step S1104: NO) or if the CPU #m determines that the threads THx and THi are not executed by the same CPU (step S1105: NO), the CPU #m proceeds to the process at step S1108. If all the threads are searched and the CPU #m determines that the thread THi is not present (step S1103: NO), the CPU #m causes the contention cycle calculation process to come to an end.

FIG. 12 is a flowchart of a contention cycle calculation process to calculate the offset time period, which is the time until the first contention cycle and the contention cycle executed when the timings to start up the threads differ from each other. The contention cycle calculation process is executed by the CPU that executes the thread to be started up. Similar to the description with reference to FIG. 11, to maintain the consistency with the description made with reference to FIG. 10, the description will be made with reference to FIG. 12 assuming that the CPU #m executes the contention cycle calculation process. At steps S1201 to S1205, S1211, and S1212 in FIG. 12, processes are executed identical to those respectively at steps S1101 to S1105, S1107, and S1108 and therefore, the processes executed at such steps will not again be described.

The CPU #m acquires a time period ti from the time at which the thread THx is started up, to the time when the thread THi is allocated for the last time (step S1206). After acquiring the time period, the CPU #m determines whether a solution exists for β to be a non-negative integer in the primary congruence equation that is βTiτi≡−ti(mod Txτx) (step S1207). Whether a solution exists for a primary congruence equation may be determined using the method described with reference to FIG. 9 as the method of determining the above.

If the CPU #m determines that a solution exists for β (step S1207: YES), the CPU #m calculates an inverse element “a” with Txτx as the modulus from βTiτi≡−ti(mod Txτx) (step S1208). After calculating the inverse element “a”, the CPU #m calculates the smallest β that is acquired for β≡−a·ti(mod Txτx) and that is a non-negative integer (step S1209). As to the method of solving the primary congruence equation according to steps S1208 and S1209, the CPU #m may calculate using the Gaussian calculation method described with reference to FIG. 9.

After calculating β, the CPU #m sets βTiτi+ti to be the offset time period, which is the time until the timing at which the first access contention occurs, sets the LCM(Txτx, Tiτi) to be the contention cycle (step S1210), and proceeds to the process at step S1211. If the CPU #m determines that no solution exists for the primary congruence equation (step S1207: NO), the CPU #m proceeds to the process at step S1212.

FIG. 13 is a flowchart of the thread control process executed when the dispatch time period or the interval of the multi-core processor system 100 is changed. Although the thread control process depicted in FIG. 13 can be executed by any one of the CPUs, it is assumed for the simplification of the description that the above process is executed by the CPU #0.

The CPU #0 sets a variable j to be one (step S1301) and determines whether the thread THj is present among the threads under execution in the multi-core processor system 100 (step S1302). If the CPU #0 determines that the thread THj is present (step S1302: YES), the CPU #0 sets the thread THj to be the thread THx, which is the thread to be processed (step S1303). After setting the thread, the CPU #0 sets the variable i used in the contention cycle calculation process to be j+1 and executes the contention cycle calculation process (step S1304).

For example, the CPU #0 sets the j-th thread that is set in the process at step S1303 for the thread THx that is set in the process at step S1101 in, for example, FIG. 11. The CPU #0 sets j+1 for the variable i that is set in the process at step S1102 and executes the contention cycle calculation process. The contention cycle calculation process depicted in FIG. 12 is similarly handled.

After executing the contention cycle calculation process, the CPU #0 determines whether the thread THx causes access contention for the shared resource to occur (step S1305). If the CPU #0 determines that the thread THx causes access contention to occur (step S1305: YES), the CPU #0 notifies the CPU that is to execute the thread that causes access contention to occur, of the marking of the contention cycle (step S1306). After giving notification of the marking, the CPU #0 executes the barrier synchronization using the barrier synchronization mechanism 205 (step S1307). The barrier synchronization is issued to each of the CPUs respectively executing threads that cause access contention to occur.

After executing the barrier synchronization or if the CPU #0 determines that the thread THx causes no access contention to occur (step S1305: NO), the CPU #0 increments the variable j (step S1308) and proceeds to the process at step S1302. When all the threads have been searched and the CPU #0 determines that the thread THj is not present (step S1302: NO), the CPU #0 causes the thread control process to come to an end.

Plural calculation sessions to acquire the least common multiple need to be executed in the thread control process depicted in FIG. 13. For example, it is assumed that N threads are present that access the shared resource in the multi-core processor system 100, and the interval of the thread THn (n=1, 2, . . . , N) is denoted by “Tn”, the dispatch time period thereof is denoted by “τn”, and the dispatch cycle thereof is denoted by “Tnτn”. The number of threads whose access contention with the thread TH1 needs to be calculated is N−1. For example, the CPU #0 calculates the LCM(TH1·τ1, TH2·τ2), the LCM(TH1·τ1, TH3·τ3), . . . , the LCM(TH1·τ1, THN·τN) as the access contention with the thread TH1. However, the threads to be executed by the same CPU as that of the TH1 are not included in those for which the calculation is executed.

Similarly, the number of threads for which the access contention with the thread TH2 is calculated is N−2. For example, the CPU #0 calculates the LCM(TH2·τ2, TH3·τ3), the LCM(TH2·τ2, TH4·τ4), . . . , the LCM(TH2·τ2, THN·τN) as the access contention with the thread TH2. The CPU #0 continues the calculation as above. In this manner, the number of threads for which the access contention is calculated decreases and the number of threads for which the access contention with the thread THN is calculated is zero.

Based on the above, the number of calculation sessions Σn(n=1, . . . , N−1) for the access contention is Σn=(1/2)·N·(N−1). For example, when the number N of threads in the multi-core processor system 100 is N=4, the number of calculation sessions is six. The opportunity for the thread control process to occur depicted in FIG. 13 is once every several seconds and therefore, increase of the overhead that is associated with the thread control process depicted in FIG. 13 is minimal.

As described, according to the multi-core processor system, the thread control method, and the thread control program, the contention cycle is calculated from the cycles of two threads that are periodically executed by two cores and that cause access contention for the shared resource to occur. At the contention cycle, the multi-core processor system switches the time at which one thread is allocated, with the time at which the other thread is allocated (this allocation time being before or after the time at which the one thread is allocated). Thereby, the multi-core processor system can prevent access contention because the times at which the shared resource is accessed are shifted; can execute two threads that cause the access contention to occur; and therefore, can maintain processing performance.

For example, as a method of calculating the contention cycle, the contention cycle may be calculated by multiplying the dispatch cycles of the two threads. Thereby, the multi-core processor system can calculate the contention cycle without imposing any heavy load; and when the dispatch cycles of the two threads are relatively prime to each other, can calculate all the contention timings.

The multi-core processor system may calculate the contention cycle using a common multiple of the dispatch cycles of the two threads. Thereby, the multi-core processor system can calculate all the timings at which the two threads cause contention to occur; and can maintain processing performance by preventing all access contention.

The multi-core processor system may calculate relative to the time at which a first thread among the two threads is allocated and based on the time at which a second thread is allocated for the last time and based on the dispatch cycles of the first and the second threads, the offset time period, which is the time until the contention cycle. Thereby, even when the times at which the allocation sessions of the two threads are started differ, the multi-core processor system can calculate the timing at which the first access contention occurs and can maintain processing performance by preventing access contention.

The multi-core processor system may set the times at which allocation sessions of arbitrary threads are started to be the same time for two cores that cause access contention to occur. Usually, when threads are allocated to two cores, the time at which the thread is allocated is different between the cores. Therefore, even when the multi-core processor system calculates the contention cycle, the time at which the thread is allocated may differ among the cores and therefore, access contention is caused to occur.

For example, it is assumed that the dispatch time period of each of the first and the second cores is 50 [microseconds] and the time at which the thread is allocated to the second core is later by two [microseconds] than the time at which the thread is allocated to the first core. When the contention cycle is calculated to be 250 [microseconds], the first thread is allocated between 250 and 300 [microseconds] and the second thread is allocated between 252 and 302 [microseconds]. When the first thread is switched with the succeeding thread and is allocated between 300 and 350 [microseconds], access contention between 252 and 300 [microseconds] can be prevented while access contention between 300 and 302 [microseconds] can not be prevented.

To avoid the state above, the multi-core processor system can maintain processing performance while preventing access contention by setting the times at which allocation sessions of the threads are started to be the same time using the barrier synchronization, etc.

The multi-core processor system of the embodiment does not impose any execution limitations such as queuing and the suppression of execution of threads. Therefore, the threads that would be subject to such limitation suffer no performance degradation and can maintain processing performance.

The multi-core processor system of the embodiment needs no special hardware mechanism. However, an effect is also achieved by applying the embodiment to a multi-core processor system having a special hardware mechanism provided for the shared resources.

For example, a case is assumed where the embodiment is applied to a multi-core processor system applied with a queuing scheme 2 as a scheme of operating the shared resources. In the case of the multi-core processor system formed by applying the embodiment to the queuing scheme 2, no access requests accumulate in an arbitration circuit and therefore, the multi-core processor system can operate normally even when power to the arbitration circuit is turned off. As described, by applying the embodiment, power to unnecessary hardware mechanisms can be turned off, thereby enabling reduced power consumption.

The thread control method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A multi-core processor system comprising:
a first core configured to:
detect a state where a first thread that is allocated to a first core among a plurality of cores and a second thread that is allocated to a second core different from the first core and among the cores access a common resource;
calculate, upon detecting the state and based on a first cycle for the first thread to be allocated to the first core and a second cycle for the second thread to be allocated to the second core, a contention cycle for the first and the second threads to cause access contention for the resource; and
select a thread allocated at a time before or after the contention cycle of a core to which a given thread that is any one among the first and the second threads is allocated at the calculated contention cycle; and
a second core configured to
switch the time at which the given thread is allocated and the time at which the selected thread is allocated.

2. The multi-core processor system according to claim 1, wherein
the first core, upon detecting the state, calculates the contention cycle by obtaining a common multiple of the first and the second cycles.

3. The multi-core processor system according to claim 1, wherein
the first core, upon detecting the state, calculates as the contention cycle, a time at which a first access contention occurs after the time at which the first thread is allocated, the first core calculating the contention cycle based on a time that is before a time at which the first thread is allocated to the first core and at which the second thread is allocated to the second core for a last time, and based on the first and the second cycles.

4. The multi-core processor system according to claim 1, wherein
the first and the second cores are configured to respectively set the same time for the start of allocation of arbitrary threads to be allocated to the first and the second cores, when the first core calculates the contention cycle, and
the first core selects a thread allocated at a time before or after the contention cycle of the core to which the given thread is allocated at the contention cycle, when the first and the second cores set the same time for the start of allocation of the arbitrary threads.

5. A thread control method executed by a first core, the thread control method comprising:
detecting a state where a first thread that is allocated to the first core among a plurality of cores and a second thread that is allocated to a second core different from the first core and among the cores access a common resource;
calculating, upon detecting the state and based on a first cycle for the first thread to be allocated to the first core and a second cycle for the second thread to be allocated to the second core, a contention cycle for the first and the second threads to cause access contention for the resource;
selecting a thread allocated at a time before or after the contention cycle of a core to which a given thread that is any one among the first and the second threads is allocated at the calculated contention cycle; and
notifying the core to which the given thread is allocated, of an instruction to switch the time at which the given thread is allocated and the time at which the selected thread is allocated.

6. A computer-readable recording medium storing a thread control program that causes a first core to execute a process comprising:
detecting a state where a first thread that is allocated to the first core among a plurality of cores and a second thread that is allocated to a second core different from the first core and among the cores access a common resource;
calculating, upon detecting the state and based on a first cycle for the first thread to be allocated to the first core and a second cycle for the second thread to be allocated to the second core, a contention cycle for the first and the second threads to cause access contention for the resource;
selecting a thread allocated at a time before or after the contention cycle of a core to which a given thread that is any one among the first and the second threads is allocated at the calculated contention cycle; and
notifying the core to which the given thread is allocated, of an instruction to switch the time at which the given thread is allocated and the time at which the selected thread is allocated.
